(19) United States
(12) Patent Application Publication
(10) Pub. No.: US 2023/0115738 A1
(43) Pub. Date: Apr. 13, 2023

(54) LOW-PRESSURE MERCURY VAPOUR DISCHARGE LAMP AND LAMP SYSTEM

(71) Applicant: Heraeus Noblelight GmbH, HANAU (DE)

(72) Inventors: Anna Maria SHARMA, Hanau (DE); Jan WINDERLICH, Hanau (DE); Franz-Josef SCHILLING, Hanau (DE); Holger KURZ, Alzenau (DE)

(21) Appl. No.: 17/906,136

(22) PCT Filed: Mar. 3, 2021
(86) PCT No.: PCT/EP2021/055330

§ 371 Date: Sep. 12, 2022

(30) Foreign Application Priority Data
Mar. 17, 2020 (DE) 10 2020 203 417.6

(51) Int. Cl. H01J 61/52; H01J 61/72; H01J 61/28; H01J 61/04; H01J 61/067

(52) U.S. Cl. CPC H01J 61/523; H01J 61/28; H01J 61/045; H01J 61/72; H01J 61/0672

(57) ABSTRACT

The invention relates to a low-pressure mercury vapour discharge lamp comprising a discharge vessel which encloses a discharge chamber in a gas-tight manner with said discharge chamber being provided with a filling of mercury and a filler gas, in particular a noble gas, wherein the discharge vessel has a first end section and a second end section , a first electrode arranged on the first end section and a second electrode arranged on the second end section for maintaining a discharge along a discharge path between the first electrode and the second electrode , and an amalgam deposit for regulating the mercury vapour pressure in the discharge chamber is arranged on the first end section outside the discharge path , wherein the position of the amalgam deposit is secured by means of an adhesion agent .

The invention relates to a low-pressure mercury vapor discharge lamp. Low-pressure mercury vapor discharge lamps are used, for example, in systems for drinking-water disinfection or for wastewater treatment. Low-pressure mercury vapor discharge lamps can also be used for water disinfection in pisciculture. Other fields of application include surface disinfection or disinfection of air in air-conditioning and cooling systems. Low-pressure mercury vapor discharge lamps reach very high UV power densities and can be used at different ambient temperatures.

In a low-pressure mercury vapor discharge lamp, mercury is used to produce ultraviolet (UV) light. During the operation of a low-pressure mercury vapor discharge lamp, its service life and operational efficiency are significantly influenced by the vapor pressure of the mercury. The mercury vapor pressure is highly dependent on the temperature of the mercury in the lamp. To allow the mercury to be handled safely and easily, in many cases an amalgam is used. In the context of the present application, both metallic mercury alloys and mercury salts, such as mercury iodide, can be referred to as amalgam. The optimal mercury vapor pressure required for the efficient operation of a low-pressure mercury vapor lamp is temperature-dependent. The temperature at which the optimum vapor pressure is established is material-dependent. For a specific amalgam or a specific mixture of different amalgams, the material-specific ideal temperature for the operation of a mercury low-pressure mercury vapor discharge lamp can be determined easily, for example experimentally. The material-dependent ideal temperature of any commercially available low-pressure mercury vapor discharge lamps can be regarded as predetermined with respect to the design of an installation. The structural design and/or regulation of the lamp system can be designed by the person skilled in the art on the basis of the previously known ideal temperature of the amalgam.

Different concepts are known for the efficient operation of low-pressure mercury vapor discharge lamps.

DE 10 2008 032 608 A1 discloses a method for operating an amalgam lamp, by means of which the start-up time is reduced. The start-up time denotes the period of time required to reach a desired operating temperature, which can correspond to the ideal temperature when a cold amalgam lamp or low-pressure mercury vapor discharge lamp is being activated. The lamp disclosed in DE 10 2008 032 608 A1 is equipped with an amalgam deposit on the inside of the lamp tube, which is heated by an infrared emitter. An adhesion-promoting layer made of a precious metal can be applied between the quartz lamp tube and the amalgam deposit. Before the lamp is ignited, the amalgam deposit is heated using the infrared lamp and, as a result, mercury vapor is released, which is already available to the discharge during ignition, so that a high UV power density is already available when the lamp is switched on. As a result of the arrangement of the amalgam in the discharge path of the low-pressure mercury vapor discharge lamp between the electrodes thereof, the temperature of the amalgam deposit during operation of the lamp is high and can significantly exceed a desired operating temperature, particularly in the case of high ambient temperatures or during prolonged operation, so that the efficiency of the lamp decreases.

According to EP 3 267 466 B1, a low-pressure mercury vapor discharge lamp is provided, in which an amalgam deposit is to be arranged in the vicinity of an electrode, but outside the discharge path between the electrodes of the lamp, in order to use the heat dissipation of the electrode for controlling the temperature of the amalgam deposit during the operation of the lamp. In order to prevent the amalgam overheating and the ideal temperature being exceeded, or in the worst case scenario even melting, EP 3 267 466 B1 proposes providing the lamp cladding tube with a constriction between the electrode coil and the amalgam deposit in order to shield the amalgam deposit, by means of the constriction, from the direct thermal radiation emitted by the coil. A disadvantage of this embodiment is the the close connection between the temperature and heat radiation of the electrode coil and the temperature of the amalgam deposit. Particularly during continuous operation, it is found that the optimal efficiency yield with such a lamp cannot be ensured because the amalgam deposit is excessively heated and, in the worst case, can even melt. On the other hand, particularly in the case of cool ambient temperatures, for example in a water disinfection plant, it is found that the amalgam deposit is often not supplied with sufficient heat to reach the ideal temperature of the amalgam deposit.

EP 3 298 620 B1 proposes a device for the regulated temperature control of a gas discharge lamp which has an amalgam reservoir with amalgam deposit. The amalgam reservoir should be formed by a glass tube closed at one end that is formed at an axial end of the lamp. Furthermore, the device should comprise a sleeve made of a thermally conductive material which can be pushed onto the amalgam reservoir. Alternatively, the amalgam reservoir can be formed by a pocket which is formed on an axial end of the gas discharge lamp or by a partial area of an inner wall of the glass bulb enclosing the mercury vapor. An electrical heating element for heating the amalgam reservoir should be arranged outside the glass tube close to the amalgam reservoir.

The heating element should be formed by a transformer core, which is part of a transformer, the secondary winding of which is connected to a temperature regulation electronics system.

It can be regarded as an object of the invention to provide an especially improved alternative for a low-pressure mercury vapor discharge lamps and/or a lamp system with a low-pressure mercury vapor discharge lamp, which overcomes the disadvantages of the prior art and, in particular, ensures a permanently safe and efficient lamp operation regardless of environmental conditions.

This object is achieved by the subject-matter of Claim 1. Accordingly, a low-pressure mercury vapor discharge lamp is provided, which comprises a discharge vessel that encloses a discharge chamber in a gas-tight manner with said discharge chamber being provided with a filling of mercury and a filler gas, in particular a noble gas, wherein the discharge vessel has a first end section and a second end section. The first end section can be arranged opposite the second end section. The discharge vessel can be a generally elongated, tubular body. In particular, the discharge vessel can be formed from a material that is at least partially translucent for ultraviolet light, such as a glass, for example a borosilicate glass or a quartz glass.

The low-pressure mercury vapor discharge lamp further comprises a first electrode arranged on the first end section and a second electrode arranged on the second end section for maintaining a discharge along a discharge path between the first electrode and the second electrode. According to one embodiment, the first electrode can be an anode and the second electrode can be a cathode. According to an alternative embodiment, the first electrode can be a cathode and the second electrode can be an anode. Low-pressure mercury vapor discharge lamps can in particular have a cylindrical emitter tube made of quartz glass, which forms a discharge vessel. The discharge vessel or emitter tube can be closed in a gas-tight manner at both ends by means of crimping. Electrodes with contact wires for the power supply are guided through the end sections which are closed in a gas-tight manner. The mercury in the discharge vessel can in particular be introduced as an amalgam. The low-pressure mercury vapor discharge lamp with amalgam deposit has an emission spectrum with characteristic lines at 185 nm (UV-A radiation) and/or 254 nm (UV-C).

According to the invention, the low-pressure mercury vapor discharge lamp comprises an amalgam deposit for regulating the mercury vapor pressure, which is arranged in the discharge chamber on the first end section outside the discharge path, wherein the position of the amalgam deposit is secured by means of an adhesion agent. The amalgam deposit can have a metallic mercury alloy or a mercury salt, such as mercury iodide or mercury bromide, or a combination thereof. Preferably, the amalgam may comprise mercury and at least one of the following elements: Li; Be; Na; Mg; AI; K; Ca; Sc; Ti; Ni; Cu; Zn; Ga; As; Rr; Sr; Y; Zr; Pd; Ag; Cd; In; Sn; Se; Cs; Ba; Hf; Pt; Au; TI; Pb; and/or Ra. Preferably, the amalgam may comprise mercury and at least one noble metal or consist of mercury and one or more precious metals; in particular Au, Pd, and/or Pt.

The discharge path as defined herein comprises the full volume element of the interior of the discharge vessel between the first electrode and the second electrode, but not the axial end regions of the discharge vessel beyond the electrodes.

The adhesion agent may have at least one of the following elements or alloys thereof; in particular, the adhesion agent may consist of one or more of the following elements: Li; Be; Na; Mg; AI; K; Ca; Sc; Ti; Ni; Cu; Zn; Ga; As; Rr; Sr; Y; Zr; Pd; Ag; Cd; In; Sn; Se; Cs; Ba; Hf; Pt; Au; TI; Pb; and/or Ra. Preferably, an adhesion agent can comprise or consist of nickel, palladium, silver, platinum and/or gold. The adhesion agent used may in particular be a metal material which can be processed, in particular melted and/or deformed, in atmospheric ambient air. In particular, a metal material that does not impair the emitter operation can be used as the adhesion agent; in particular, the adhesion agent layer can be free of lithium and/or free of sodium, which attack the quartz glass of the glass vessel. The adhesion agent is in particular free of organic materials. The adhesion agent preferably comprises metallic materials or consists of metallic materials. Preferably, the first electrode can be arranged at a predetermined distance from the adhesion agent, wherein the predetermined distance is dimensioned such that the temperature of the amalgam deposit is independent of a predetermined discharge current, in particular a nominal discharge current, of the first electrode.

The regulation electronics can be configured to adjust the temperature of the amalgam deposit such that the mercury vapor pressure in the discharge region is in an optimum pressure range. In the optimum pressure range, the light output of the low-pressure mercury vapor discharge lamp corresponds to at least 90% of the highest possible light output. The highest possible light output of a low-pressure mercury vapor discharge lamp is predetermined as a function of the specific amalgam and of the geometry of the discharge vessel of the low-pressure mercury vapor discharge lamp. The highest possible light output is achieved when the amalgam deposit is brought to its ideal temperature. The regulation electronics can be configured to regulate the temperature of the amalgam deposit such that the temperature of the amalgam deposit is within an optimum temperature range. The optimum temperature range can correspond to the optimum pressure range. The optimum temperature range can, for example, allow a deviation of no more than ±10° C., preferably no more than ±5° C.; particularly preferably no more than ±2° C., relative to the ideal temperature. In particular, within the optimum pressure range, the product of the mercury vapor pressure P_{Hg} in the low-pressure mercury vapor discharge lamp and the inner diameter D of the discharge vessel is at least 0.13 and at most 5 Pa*cm, preferably at least 1 and at most 4.5 Pa*cm, particularly preferably at least 1.3 and at most 4 Pa*cm. The determination of the optimum pressure range of a low-pressure mercury vapor discharge lamp is described, for example, in “Discharge Lamps, Chr. Meyer and H. Nienhuis, Kluwer, 1988, 70-72, ISBN 90 201 2147 2”.

According to one embodiment of a low-pressure mercury vapor discharge lamp according to the invention, the first electrode comprises at least one contact wire which extends from the first electrode in the discharge chamber to outside the discharge vessel. In particular, the first electrode can have exactly one or exactly two contact wires which extend from the electrode in the discharge chamber to outside the discharge vessel. The electrode can be formed with a helical incandescent body which extends in the discharge chamber from a first contact wire to a second contact wire. The first electrode can be supplied with the discharge current for the discharge by means of the first contact wire and/or the second contact wire.

The contact wire has a dielectric sheathing at least in sections, in particular continuously, within the discharge chamber. The dielectric sheathing may be formed from an inorganic material, in particular from a ceramic material, a glass material or a combination thereof. In particular, the dielectric sheathing can consist of a glass, such as borosilicate glass or quartz glass. The adhesion agent is preferably arranged on the sheathing. It may be preferred that the at least one contact wire, in particular the exactly two contact wires, are held and/or supported by the sheathing. It may be preferred that the adhesion agent and the amalgam deposit are supported and/or held by the sheathing. In particular, the amalgam deposits and the adhesion agent are held on the sheathing in a contact-free manner with respect to the at least one contact wire, so that adhesion agent and amalgam deposit are neither directly nor indirectly supported by at least one contact wire, but rather the structural mounting of the amalgam deposit and of the adhesion agent is effected exclusively by means of the sheathing. The dielectric sheathing of at least one contact wire can be arranged outside the discharge path between the electrodes in the first end section of the discharge vessel. Preferably, the sheathing is located completely outside the discharge path in the first end section of the discharge chamber of the low-pressure mercury vapor discharge lamp.

The at least one contact wire can comprise a contact region in which the contact wire with the first electrode is preferably in contact with the first electrode outside the sheathing. The contact wire and the first electrode can be contacted, for example, as a soldered connection, a screw connection, a plug connection, a welded connection or the like. The contact wire and the electrode can be connected to one another for transmitting the discharge current for the discharge. It may be preferable for the contact wire to be formed from or consist of a first electrically conductive material, such as molybdenum or a molybdenum alloy. In particular, the electrode can be formed from or consist of a second electrically conductive material, such as tungsten or a tungsten alloy.

The dielectric sheathing may continuously wrap the at least one contact wire in the first end section. Between the sheathing and the electrode a transition region can be provided in which the contact wire extends within the discharge vessel without sheathing. The dielectric sheathing of the at least one contact wire can extend continuously from the axial first end section of the discharge vessel to the electrode, to the contact region or to a transition region between the electrode or the contact region without interruption. In particular, the adhesion agent and/or the amalgam deposit is arranged exclusively on the tape-shaped sheathing.

According to a development of a low-pressure mercury vapor discharge lamp according to the invention, the sheathing sealingly encloses the contact wire. In particular, the sheathing can be formed by pressing the dielectric material onto the contact wire. It can be preferred that the sheathing sealingly surrounds the contact wire in such a way that, along the contact wire, no ambient air can penetrate into the discharge chamber and/or the no mercury fluid, no mercury vapor, and/or no filler gas can escape from the discharge chamber into the environment outside the low-pressure mercury vapor discharge lamp. In general, standard conditions can be assumed as ambient conditions, i.e. an atmospheric pressure of 1013 hPa and an ambient temperature of 25° C.

Preferably, the contact wire can be formed within the sheathing with at least one sealing platelet, wherein the sealing platelet forms the contact wire in sections in particular in the axial direction. The sealing platelet can have an elliptical, rhombic (with rounded corners) or similar flattened cross-section, which preferably has a smallest transverse width in a transverse direction, which corresponds to the constant transverse width of the contact wire in the axial direction before and/or after the sealing platelet. The sealing inclusion of the contact wire by means of the sheathing can take place in particular in the region of the sealing platelet.

According to a development of a low-pressure mercury vapor discharge lamp, which can be combined with the previous one, the sheathing is formed from the same material as the discharge vessel. Preferably, the sheathing can consist of the same material as the discharge vessel. The sheathing and the discharge vessel can be formed from or consist of a glass material, in particular quartz glass. By using the same material for the sheathing and the discharge vessel, the production of a low-pressure mercury vapor discharge lamp can be realized particularly easily in a consistent and reliable manner. One or more amalgam deposits can be arranged in the same way on the sheathing, a heat shield and/or the discharge vessel by means of adhesion agents.

According to a development of a low-pressure mercury vapor discharge lamp, the sheathing extends in a tape-like manner into the discharge chamber. In particular, the sheathing at the axial end of the discharge vessel can extend continuously in the form of a tape into the discharge chamber. In particular, the width of the tape-shaped sheathing is smaller than an inner diameter of the discharge vessel, wherein in particular the width measures more than 50%, preferably more than 75% and/or less than 95%, preferably less than 90% of the inner diameter. Preferably, the width may be about 85% of the inner diameter. In particular, the thickness of the tape-shaped sheathing is less than half of the inner diameter of the discharge vessel, wherein the thickness measures more than 10%, preferably more than 20%, and/or less than 40%, preferably less than 30% of the inner diameter. Preferably, the thickness may be about 20% of the inner diameter. In particular, the height of the tape-shaped sheathing can substantially correspond to the diameter of the discharge vessel. The height measures in particular more than 50%, preferably more than 60%, and/or less than 150%, preferably less than 125% of the inner diameter. Preferably, the height may be about 75% or about 100% of the inner diameter.

According to a preferred development, the tape-shaped sheathing can have a substantially rectangular cross section. The sheathing can have unevenness, for example undulating unevenness, in particular on the lateral side faces. Preferably, the sheathing is free of recesses on its lateral side faces. According to a development of a low-pressure mercury vapor discharge lamp, the adhesion agent is arranged on a lateral surface of the sheathing. Alternatively or additionally, an end face of the sheathing facing the first electrode can be free of an adhesion agent. The end face of the sheathing facing the first electrode can be free of the amalgam deposit. By arranging the adhesion agent and/or the amalgam deposit on a lateral surface on a longitudinal side of predetermined width and/or a transverse side of predetermined thickness, a precise and highly reproducible distance between the incandescent body of the first electrode and the amalgam deposit can be adjusted using simple means during the production of the low-pressure mercury vapor discharge lamps. The end face of the sheathing facing the first electrode can have a cross-section that is laterally enlarged relative to the cross-section of the tape-shaped sheathing along the axial height of the tape-shaped sheathing and/or can be provided with a heat shield. In such an embodiment, thermal radiation from the incandescent body of the first electrode is kept away from the amalgam deposit on the lateral surface of the sheathing, so that the axial distance between the electrode and the amalgam deposit can be relatively small in dimension.

According to a development of a low-pressure mercury vapor discharge lamp, the sheathing is fastened, in particular welded, in the first end section of the discharge vessel. The band-shaped sheathing can be formed integrally with the first end section and/or a preferably plate-like connecting section of the discharge vessel. It is conceivable that the tape-shaped sheathing is connected to the first end section of the discharge vessel in an integrally bonded manner. For example, the tape-shaped sheathing can be connected to the first end section by welding, in particular friction welding. The first end section of the discharge vessel can have a foot section with a smaller inner and/or outer diameter, like that the inner and/or outer diameter discharge vessel, in particular in a cylindrical tube section along the discharge path. The wall thickness of the discharge vessel can be the same in the first end section and along the discharge vessel. The first end section of the discharge vessel can be formed free of a crimp in the axial direction on the outside. In particular, the tape-shaped sheathing within the discharge vessel can be formed on the first end section as a crimp.

According to one embodiment of a low-pressure mercury vapor discharge lamp according to the invention, which can be combined with the previous one, at least one heat shield is arranged between the first electrode and the first end section, wherein the adhesion agent and optionally the amalgam deposit are arranged opposite the heat shield with respect to the first electrode. It may be preferred that the heat shield is arranged such that the temperature of the amalgam deposit is independent of the discharge current of the first electrode, in particular the temperature of an incandescent body of the first electrode. The heat shield can be formed, for example, from an inorganic material, such as a ceramic material, a glass material, in particular quartz glass. In the axial direction, the heat shield preferably has a thickness of at least 1 mm, in particular at least 5 mm and/or no more than 10 mm, in particular 2 mm or less. The material of the heat shield can preferably be a material that reflects infrared light at least partially. In particular, the material of the heat shield can be designed to reflect infrared radiation to a wavelength spectrum of 780 nm or more, in particular 780 nm to 3000 nm, to at least 50%, at least 75% or at least 90% . The heat shield can be formed at least partially from an amorphous opaque quartz glass. It is conceivable that the heat shield is partially formed from a metal material, for example aluminum or gold. In particular, the heat shield, with the exception of at least one section directly adjoining at least one contact wire, can be formed with a metal material, in particular coated therewith or consist thereof. According to one embodiment of a low-pressure mercury vapor discharge lamp, the heat shield can be formed at least partially by the tape-shaped sheathing. Such a heat shield formed by the sheathing can be provided as an alternative to or in addition to a disk-shaped heat shield. Alternatively or additionally, the electrode can have at least one contact wire for supplying the first electrode with a discharge current, wherein the at least one contact wire carries a disk-like heat shield.

The heat shield can be provided with a coating that reflects infrared light. Such a coating may comprise a metal, an alloy, a heat-resistant polymer, for example, PTFE, or a ceramic material, for example a silicate. Examples of suitable metals are aluminum or precious metals, such as gold or silver. The coating reflecting infrared light can be arranged on the side of the heat shield facing the incandescent body of the first electrode and/or on the side of the heat shield facing away from the incandescent body of the first electrode. In particular, the coating reflecting infrared light can be designed to reflect infrared radiation to a wavelength spectrum of 780 nm or more, in particular 780 nm to 3000 nm, to at least 50%, at least 75% or at least 90%. In one embodiment, the heat shield comprises quartz glass and a coating that reflects infrared light comprising a metal, an alloy, or a ceramic material. If the coating reflecting infrared light is electrically conductive, it may be advantageous to arrange it such that there is no electrical contact between the electrode and the heat-reflecting coating. Optionally, an electrically insulating means can be arranged between the electrode and the heat-reflecting coating, and/or the coating reflecting infrared light can include a recess in order to prevent an electrical short circuit with the electrode.

The heat shield itself can also be formed from such a material that reflects infrared light.

The heat shield can, at least in sections, be formed to have a shape that is complementary to an inner side of the discharge vessel. For example, the heat shield can have a plurality of discrete circumferential sections, for example two circumferential sections, three circumferential sections, four, five or more circumferential sections on which the heat shield is in contact with an inner side of the discharge vessel. These circumferential sections can be referred to as circumferential contact sections. Between adjacent circumferential contact sections, such a heat shield has radial recesses in which the heat shield is contact-free with respect to the inner circumference of the discharge vessel. Preferably, a heat shield comprises at least one, in particular two or more radial recesses through which a gas exchange between the region of the amalgam deposit and the discharge path can take place in the discharge vessel. At least one through-opening can be formed between the heat shield and the discharge vessel, through which the mercury vapor from the amalgam deposit can reach the discharge path.

The heat shield can have at least one wedge-shaped radial recess for receiving, in particular inserting, the at least one contact wire. In a discharge lamp, the first electrode of which has two contact wires, it may be preferred for a heat shield to have at least one first wedge-shaped recess for receiving a first contact wire and a second wedge-shaped recess for receiving a second contact wire. The at least one contact wire can be equipped with a projection for supporting the heat shield. For example, a bearing sleeve, which is in particular metal and preferably made of nickel, can be provided on the contact wire. According to one embodiment, the heat shield is held in a stationary manner on at least one contact wire. The at least one contact wire can be held by the at least one contact wire with at least one axial stop, such as a projection, and/or by a frictional connection, wherein the connection between the heat shield and the at least one contact wire can be formed by an at least partially oblique, wedge-shaped, helical or other uneven axial extension of the contact wire. The heat shield can be arranged in contact with one of the first electrodes, in particular with an incandescent body of the first electrode. The first electrode can form a stop for immovably holding the heat shield.

According to one embodiment of a low-pressure mercury vapor discharge lamp, the heat shield can be formed from a dielectric material. In particular, the heat shield can be formed from transparent quartz glass and/or amorphous quartz glass, preferably semiconductor-doped amorphous quartz glass.

The low-pressure mercury vapor discharge lamp can further comprise, in addition or as an alternative to the heat shield, a sleeve that reflects infrared light, which at least partially surrounds the amalgam deposit. The sleeve reflecting infrared light can be configured and arranged to thermally shield the amalgam deposit from the environment. As a result, more uniform operation of the lamp and/or faster starting of the lamp can be achieved. The sleeve reflecting infrared light can make operation of the lamp independent of the overall temperature of the lamp and the temperature of the external environment. The sleeve reflecting infrared light can, for example, be a cylindrical metal foil or a cylindrical sleeve made from a material that reflects infrared light. In particular, the sleeve reflecting infrared light can be designed to reflect infrared radiation to a wavelength spectrum of 780 nm or more, in particular 780 nm to 3000 nm, to at least 50%, at least 75% or at least 90%. The sleeve reflecting infrared light can be designed as a layer reflecting infrared light, which is arranged on or at a wall of the discharge vessel, in particular an outer wall of the discharge vessel. As an alternative or in addition, such a layer can also be arranged on the inner wall of the discharge vessel. The sleeve reflecting infrared light can at least partially surround the first end section of the discharge vessel, in particular the region of the first end section of the discharge vessel outside the discharge path. The sleeve reflecting infrared light can comprise a layer applied to the outer wall of the discharge vessel. Such a layer can be produced, for example, by means of vapor deposition. The sleeve reflecting infrared light can comprise a layer arranged on the outer wall of the discharge vessel. Such a layer can comprise, for example, a foil, in particular a metal foil. This layer can comprise, for example, a material which is described herein for the coating that reflects infrared light.

According to an alternative embodiment of a low-pressure mercury vapor discharge lamp, which can be combined with the previous ones, the adhesion agent can be arranged at least partially on an inner side of the discharge vessel. Optionally, the adhesion agent can be arranged exclusively on an inner side of the discharge vessel. The adhesion agent extends at least partially circumferentially, in particular completely circumferentially or only in sections, on the inside of the discharge vessel.

According to a development of a low-pressure mercury vapor discharge lamp, the amalgam deposit is equipped with an electromagnetic receiver for converting electromagnetic input signals into heat. The electromagnetic receiver can be annular, in particular coil-shaped, or gridlike. According to a development of a low-pressure mercury vapor discharge lamp, the electromagnetic receiver comprises or is formed from the adhesion agent and/or the amalgam deposit. Alternatively, the receiver can be formed separately from the amalgam deposit and/or separately from the adhesion agent.

The invention can also be a lamp system with a low-pressure mercury vapor discharge lamp and an electromagnetic transmitter for exciting the electromagnetic receiver. In particular, in the case of the lamp system, the electromagnetic transmitter and the electromagnetic receiver can be coordinated with one another in such a way that the transmitter transmits a heating current to the receiver, in particular inductively and/or capacitively, to control the temperature of the amalgam deposit. The lamp system can have at least one temperature sensor. The temperature sensor can comprise in particular a lamp temperature sensor for detecting a temperature of the lamp, in particular of the discharge vessel, of the amalgam deposit, of the filler gas and/or of the mercury vapor. Alternatively or additionally, the lamp system can comprise a temperature sensor which is realized as an ambient temperature sensor for detecting an ambient temperature of a medium, such as water or ambient air, near the discharge vessel or in contact with the discharge vessel. It is clear that the medium is located outside the discharge chamber encased in a gas-tight manner by the discharge vessel.

According to a development, the lamp system comprises regulation electronics for adjusting the temperature of the amalgam deposit, in particular taking into account a temperature detected by the at least one temperature sensor. The lamp system can further comprise a lamp holder with connection contacts or contact receptacles for the at least one contact wire of the first electrode for providing the discharge current. The lamp holder can comprise the electromagnetic transmitter, the regulation electronics and/or the at least one temperature sensor. For example, the lamp holder can comprise a housing through which the connection contacts extend, or which comprises contact receptacles for the at least one contact wire, wherein the electromagnetic transmitter, the regulation electronics and/or the at least one temperature sensor are arranged within the housing.

Preferred embodiments of the invention are specified in the claims. Particular embodiments and aspects of the invention are described below with reference to the accompanying figures, in which are shown:

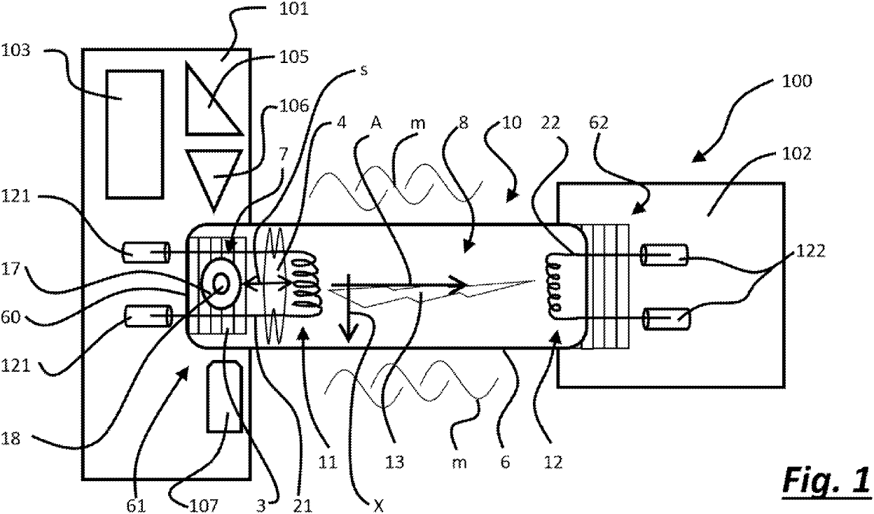

FIG. 1 an inventive lamp system with a low-pressure mercury vapor discharge lamp according to the invention according to a first embodiment;

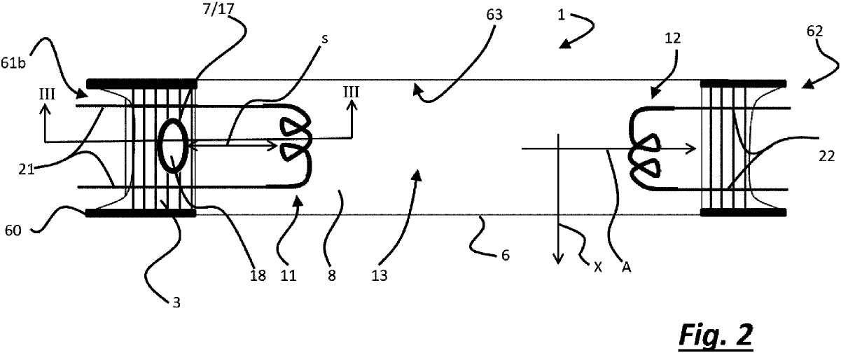

FIG. 2 a low-pressure mercury vapor discharge lamp according to a second embodiment;

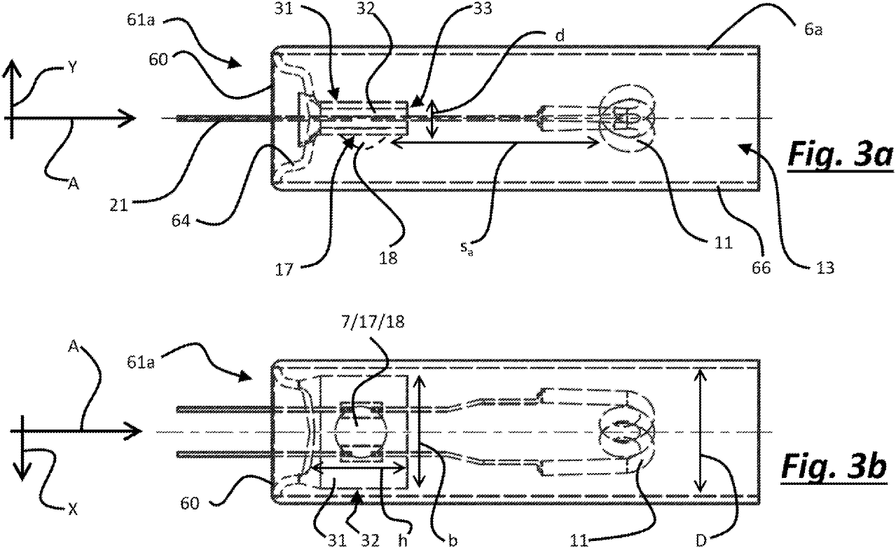

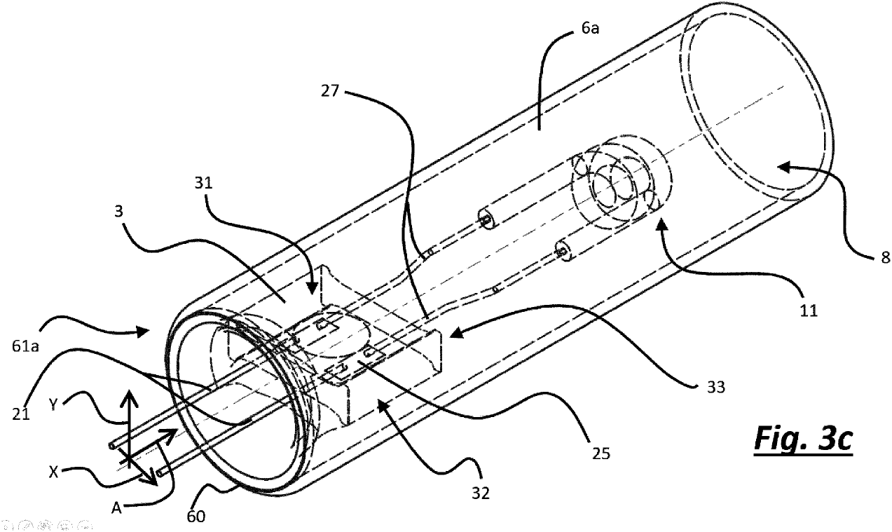

FIG. 3a a detailed view of the low-pressure mercury lamp according to FIG. 2;

FIG. 3b a side view of the detail according to FIG. 3a;

FIG. 3c a perspective view of the detail according to FIG. 3a;

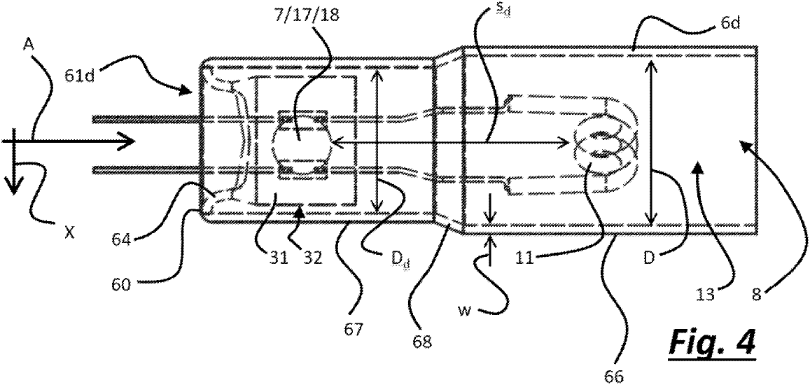

FIG. 4 a first end section of a low-pressure mercury vapor discharge lamp according to a third embodiment;

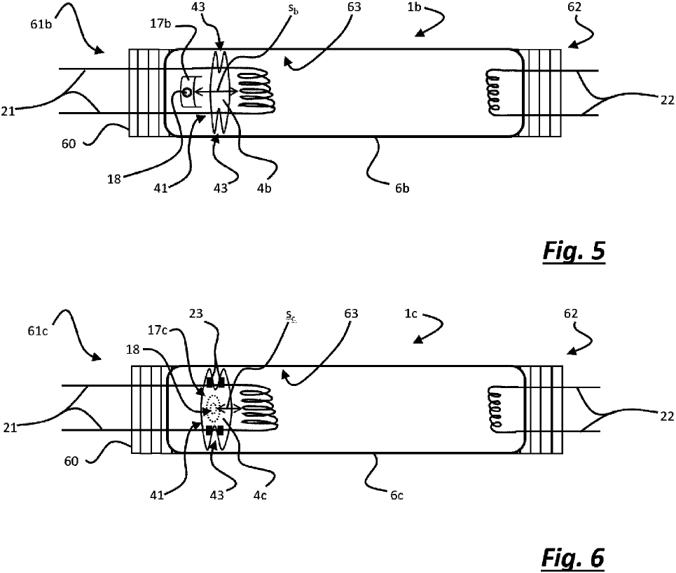

FIG. 5 a low-pressure mercury vapor discharge lamp according to a fourth embodiment;

FIG. 6 a low-pressure mercury vapor discharge lamp according to a fifth embodiment;

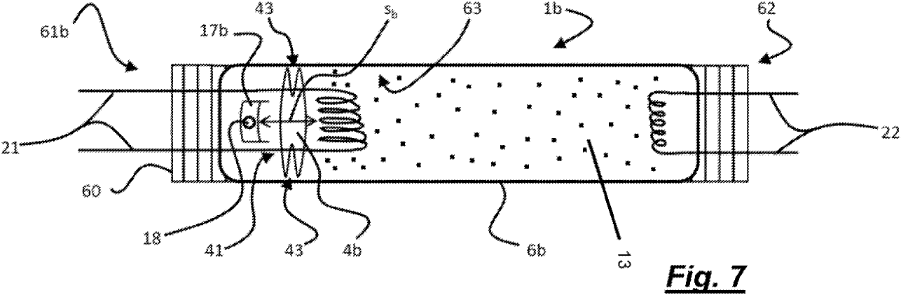

FIG. 7 the region of the discharge path of a low-pressure mercury vapor discharge lamp according to the invention;

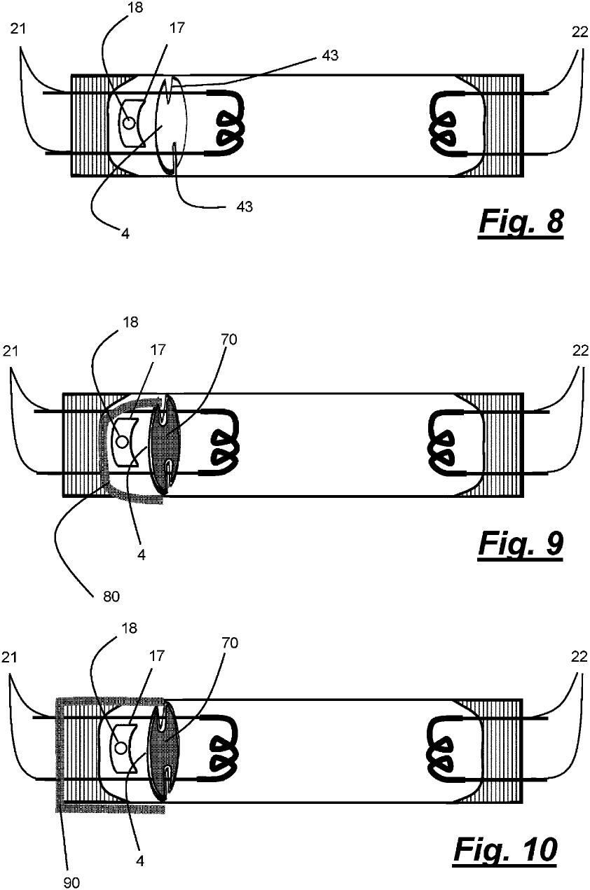

FIG. 8 a low-pressure mercury vapor discharge lamp according to a sixth embodiment;

FIG. 9 a low-pressure mercury vapor discharge lamp according to a seventh embodiment; and

FIG. 10 a low-pressure mercury vapor discharge lamp according to an eighth embodiment.

In the following description of specific embodiments on the basis of the figures, the same or similar components are provided with the same or similar reference signs for better readability. FIG. 1 shows a stylized lamp system 100 with a low-pressure mercury vapor discharge lamp 1 according to the invention. The low-pressure mercury vapor discharge lamp 1 comprises as an essential component a discharge vessel 6, with a first end section 61 and a second end section 62, which encloses a discharge chamber 8 in a gas-tight manner. During operation of the low-pressure mercury vapor discharge lamp, a filler gas and mercury vapor are contained in the discharge chamber 8.

The low-pressure mercury vapor discharge lamp 1 further comprises a first electrode 11 arranged on the first end section 61 and a second electrode 12 arranged on the second end section 62 for maintaining a discharge along a discharge path 13. Outside the discharge path 13 between the first electrode 11 and the second electrode 12 an amalgam deposit 18 for regulating the mercury vapor pressure in the discharge chamber 8 is arranged by means of an adhesion agent 17. The position of the amalgam deposit 18 is defined by the position, shape and size of the adhesion agent 17.

FIG. 1 shows a schematic section through the lamp system 100 with the low-pressure mercury vapor discharge lamp 1 provided therein through a plane which extends in the axial direction A and the first lateral direction (longitudinal direction) or radial direction X of the low-pressure mercury vapor discharge lamp 1. The low-pressure mercury vapor discharge lamp 1 can have a substantially axial extension, wherein the discharge vessel 6, particularly in the region surrounding the discharge path 13 in the radial direction X, Y, has a circular cross-section and/or can be designed in the form of a cylindrical tube. It is clear that the first end section 61 and the second end section 62 of the discharge vessel 6 seal off the discharge vessel 6, which is in the form of a cylindrical tube, in the axial direction A in the region of the discharge path 13. In this respect, the end sections 61, 62 necessarily have a shape that deviates from the cylindrical tube shape, in particular at their axial ends.

It can be preferred that the second end section 62 is produced by a stamping or crimping process, wherein for this purpose a cylindrical tube formed, for example, from quartz glass and forming the discharge vessel 6 is heated and, in a softened state, in an in particular second radial direction (transverse direction) Y is formed in a sealing manner for closing the discharge vessel 6. Referring in particular to lamps 1b and 1c, described below with respect to FIGS. 5 and 6, the first end section 61b or 61c thereof can also be shaped in such a way.

The end sections 61, 62 of the discharge vessel 6 can be arranged on a diametrically opposed axial foot of the emitter, in particular in such a way that the discharge path 13 between the first electrode 11 and the second electrode 12 extends substantially in the axial direction A. Other lamp shapes, for example omega-shaped, circular, spiral or the like, are conceivable.

An amalgam deposit 18, which is located outside the discharge path 13, which extends between the electrodes 11, 12, is arranged on the first end section 61 of the low-pressure mercury vapor discharge lamp 1 in the discharge chamber 8. Thanks to the arrangement of the amalgam deposit 18 outside the discharge path 13, the temperature 18 can be adjusted independently of the temperature of the arc along the discharge path 13 between the electrodes 11, 12 during the operation of the lamp 1. In order to adjust the temperature of the amalgam deposit 18, a controller and/or regulator can be provided. In the preferred embodiment shown in FIG. 1, regulation electronics 103 for regulating the temperature of the amalgam 18 are provided, which will be discussed in detail below.

To fix the arrangement of the amalgam 18 within the discharge chamber 8, an adhesion agent 17 is provided on the first end section 61 outside the discharge path 13. A metal, in particular an amalgam former, for example gold, in a preferably thin layer of less than 10 µm on an inner surface in the interior of the discharge vessel 6, can be attached as adhesion agent 17. The adhesion agent 17 serves to define a position at which the amalgam 18 collects within the discharge vessel 6 at low temperatures below the melting point of the amalgam 18.

The adhesion agent 17 is selected such that, on the one hand, a stable connection is created with a material of the discharge vessel 6, such as a quartz glass and, on the other hand, a connection is created with the amalgam deposit within the discharge vessel. The adhesion agent 17 can comprise or consist of a material which causes minimum mercury vapor pressure in the discharge chamber 8 locally in the region of the adhesion agent 17, so that mercury vapor in the discharge chamber 8 of the low-pressure mercury vapor discharge lamp condenses and/or resublimates completely or at least predominantly on the adhesion agent 17.

The lamp system 100 can have a device for controlling the temperature of the amalgam deposit 18, which device is realized in the example shown in FIG. 1 by way of example by a heating device in the form of an electromagnetic transmitter 107, which induces an electromagnetic receiver 7 to heat the amalgam 18 in a heating current for controlling the temperature of the amalgam deposit 18.

To regulate the temperature, the lamp system 1 can comprise at least one temperature sensor 105, 106. The regulation electronics 103 can be configured to control the temperature control device, for example the inductive heater 109, in order to keep the amalgam temperature as constant as possible, in particular close to the predetermined ideal temperature of the amalgam 18. The regulation electronics 103 can be configured to keep the temperature of the amalgam 18 within a range ±10° C., in particular within a range ±5° C., preferably within a range ±2° C. or ±1° C. with respect to its specific, predetermined ideal temperature.

A temperature sensor can be provided, for example, as a lamp temperature sensor 106 for detecting a temperature on or in the lamp, in particular for detecting the temperature of the amalgam 18. The mercury vapor pressure of the amalgam is strongly dependent on the amalgam temperature, as described above. The use of a lamp temperature sensor 106 for detecting the temperature of the amalgam 18 during the operation of the lamp system 100 allows regulation of the temperature of the amalgam 18 using the temperature of the amalgam deposit 18 detected with the lamp temperature sensor 106 as a manipulated variable.

Alternatively or additionally, an ambient temperature 105 for detecting an ambient temperature of the lamp 1, for example a temperature of a medium m, such as service water, can be detected. To regulate the temperature of the amalgam 18, the regulation electronics 103 can take into account an ambient temperature detected with the ambient temperature sensor 105 as an alternative to or in addition to the amalgam temperature.

The regulation electronics 103 can in particular be designed to take into account significant changes in the ambient temperature if the temperature detected with the ambient temperature sensor 105 exceeds a predetermined maximum threshold value or falls below a predetermined minimum threshold value within a predetermined period of time or, in the case of a temporally discrete measurement, within a predetermined number immediately after one another recorded of measurement. In the case of significant changes in the ambient temperature, the regulation electronics 103 can bring about a corresponding control of the temperature control device, for example of the inductive heater 109, in order to keep the amalgam temperature as constant as possible, in particular close to the predetermined ideal temperature of the amalgam 18.

The lamp system can comprise a first holder 101, which is provided with connection contacts or contact receptacles 121 for providing the discharge current to the contact wires 21 of the first electrode 11. The lamp system 100 can have a second holder 102 with contacts or contact receptacles 122 for the contact wires 22 of the second electrode 12 to provide the discharge current to the second electrode 12.

According to one embodiment, the low-pressure mercury vapor discharge lamp 1 can have an electromagnetic receiver 7 for converting electromagnetic input signals into heat for heating the amalgam deposit 17. In the embodiments shown in FIG. 1, the receiver 7 is formed from the adhesion agent 17 and the amalgam deposit 18 provided on the adhesion agent 17. The receiver 7 can be annular, for example. The electromagnetic transmitter 107 for inductively and/or capacitively transmitting the heating current to the electromagnetic receiver 7 is arranged outside the discharge vessel 6.

The electromagnetic transmitter 107 can be configured to provide an electromagnetic field or signal for the receiver 7, in particular corresponding to a resonance frequency of the receiver 7. The transmitter 107 can be structurally matched to the receiver 7. It is conceivable that the transmitter 107 is matched to the receiver 7 of a low-pressure mercury vapor discharge lamp 1, in particular its resonance frequency, by means of a calibration process carried out by a regulation device 103.

In addition to the contact receptacles 121, the regulation electronics 103, the ambient temperature sensor 105, the lamp temperature sensor 106 and/or the temperature control device, in particular the electromagnetic transmitter 109, can also be accommodated in the housing of the holder 101 (if present).

An optional heat shield 4, which shields the amalgam deposit 18 from heat radiation from the first electrode 11, is provided in the discharge chamber 8 of the low-pressure mercury vapor discharge lamp 1 between the amalgam deposit 18 and the first electrode 11. In the low-pressure mercury vapor discharge lamp 1, the distance s in the axial direction A between the incandescent body of the first electrode 11 and the amalgam deposit 8 can be dimensioned such that, during operation of the mercury discharge lamp 1 with nominal power, the temperature of the amalgam deposit 18 is independent of the temperature of the incandescent body of the first electrode 11.

FIG. 2 shows another embodiment of a low-pressure mercury vapor discharge lamp 1a according to the invention, which differs from the low-pressure mercury vapor discharge lamp shown in FIG. 1 as essentially only by the heat shield 4. The use of the heat shield 4 allows a particularly compact design. In comparison, with parameters which otherwise remain the same, the distance sₐ between the first electrode 11 and the amalgam deposit 18 in the lamp 1a shown in FIG. 2 is greater in comparison to the lamp 1 described above, in order that the temperature of the amalgam deposit 18 is independent of the temperature and of the associated heat radiation of the incandescent body of the first electrode 11 when the low-pressure mercury vapor discharge lamp 1a is operating at nominal power.

FIG. 3a shows a detail section of a low-pressure mercury vapor discharge lamp 1 according to the intersection line III-III in FIG. 2. FIG. 3b shows a plan view of the first end section 61 of the emitter 1a according to FIGS. 3a and 2. FIG. 3c shows a perspective view of the first end section 61a of the emitter according to FIGS. 3a and 3b.

As can be seen in FIG. 3a, the contact wire 21 of the first electrode 11 in the axial direction A on the first end section 61a of the low-pressure mercury vapor discharge lamp 1 A is in sections continuously and completely surrounded by a dielectric sheathing 3. The dielectric sheathing 3 can be formed, for example, from a ceramic material or a glass material, preferably quartz glass. In particular, the sheathing 3 can be formed from the same material as the discharge vessel 6a. The adhesion agent 17 with an amalgam deposit 18 placed thereon is applied to a lateral surface of the sheathing 3.

The fixing of the adhesion agent 17 to the inner surface of the low-pressure mercury vapor discharge lamp can be achieved, for example, by melting the material of the adhesion agent 17 by brief heating and/or by burning in of the inner surface of the low-pressure mercury vapor discharge lamp. The amalgam deposit 18 can be fixed on the adhesion agent 17 by melting the amalgam deposit by heating briefly. The adhesion agent 17 preferably has a significantly higher melting point than the amalgam deposit 18. For example, the melting point of the amalgam deposit 18 can be below 200° C., in particular below 100° C. The melting point of the adhesion agent 17 can be, for example, at least 400° C., in particular at least 600° C. or more.

As can be seen in FIG. 3c, the sheathing 3 can extend continuously in a tape-like manner in the axial direction A along the contact wire 21. The first lateral direction X (longitudinal direction) and the second lateral direction Y (transverse direction) can be transverse, in particular perpendicular to one another, and be transverse, in particular perpendicular, on the axial direction A. The sheathing 3 can have a substantially rectangular cross-section In the axial direction A. In the first lateral direction X, the sheathing 3 has a width b that is smaller than the inner diameter D of the discharge vessel 6 in the region of the discharge path 13. The thickness d in the second lateral direction Y of the sheathing 3 is smaller than the inner diameter D of the discharge vessel 6a in the region of the discharge path 13. The thickness d of the sheathing 3 is smaller than the width b of the sheathing 3.

The sheathing 3 can be formed by the dielectric material, in particular a glass material, preferably quartz glass, being crimped or stamped or pressed onto the contact wire or contact wires 21 of the first electrode 11. The crimping or stamping of the sheathing 3 onto the contact wires 21 of the first electrode 11 can be carried out according to the crimping process described above. The sheathing 3 projects from the connection section 64 into the discharge chamber 8 of the lamp 1 in the axial direction A. The end 60 of the lamp 1 forms its outermost position in the axial direction A, at which, for example, the cylindrical cladding tube 66 of the emitter is combined with the connecting section 64 in particular without crimping. The sheathing 3 of the contact wires 21 is arranged inside the lamp 1, at a distance from its end 60 in the axial direction A, in order to avoid undesired conductive heat transfer from the amalgam deposit 18 to the lamp holder (not shown). Undesired conductive heat transfer from the temperature-controlled amalgam deposit 18 through the end 60 of the lamp 1 to the lamp holder is also prevented by the amalgam deposit 60 not being provided in a recess at the end 60 of the lamp, but instead being held by the adhesion agent 17 in the discharge chamber 8.

The contact wire 21 of the electrode 11 can be formed in sections as a round and sectionally laminar flat section, wherein it may be preferred to initially form the contact wire 21 as flattened sealing platelet 43 in the region of the sheathing 3 in order to bring about a strong sealing effect between the dielectric material of the sheathing 3 and the electrically conductive material of the contact wire 21. The contact wire 21 can in particular be formed from molybdenum.

The width b of the sheathing 3 is slightly less than the inner diameter D. In particular, the width b of the sheathing 3 can be between 75% and 90% of the inner diameter D. The thickness D of the sheathing 3 can preferably be less than half the inner diameter D, preferably between 20% and 30% of the diameter D.

The tape-shaped sheathing 3 extends in the axial direction A continuously along a height h over the entire circumference around the at least one contact wire 21 of the first electrode 11. The height h can be greater than the thickness d and/or smaller than the width b of the sheathing 3. The height h can correspond to the inner diameter D of the discharge vessel or be smaller than the inner diameter D of the discharge vessel 6a. The height can correspond to at least 50% and/or at most 150% of the inner diameter D of the discharge vessel 6a. Preferably, the height may correspond to at least 66% and/or at most 100% of the inner diameter. According to one embodiment, the height h can correspond to approximately 75% of the inner diameter D.

The adhesion agent 17 and the amalgam deposit 18 are arranged on at least one lateral surface (longitudinal side) 31 or (transverse side) 32 of the sheathing 3. The amalgam deposit 18 is arranged on a lateral side face 31 or 32 facing out of the discharge vessel 6 in the first lateral direction X or the second lateral direction Y. The end face 33 of the sheathing 3 facing the electrode 11 is free of adhesion agent 17 and free of amalgam 18.

In the embodiments shown in FIGS. 3a, 3b and 3c, the adhesion agent 17 with the amalgam deposit 18 is provided on a wide lateral surface 31 of the sheathing 3 extending in the first lateral direction X. It is conceivable that an adhesion agent 17 with an amalgam deposit 18 is arranged exclusively on just one of the lateral surfaces 31 and 32 of the sheathing 3. Alternatively, the adhesion agent and optionally the amalgam 18 can be arranged on two or three, in particular on all lateral surfaces 31, 32 of the sheathing 3.

The distance sₐ between the amalgam deposit 18 and the incandescent body of the electrode 11 is dimensioned such that the temperature of the amalgam deposit 18 is independent of the discharge current of the first electrode 11 when the low-pressure mercury vapor discharge lamp 1a is operating at nominal power.

The sheathing 3 can be connected at its foot facing in the axial direction A away from the first electrode 11 via a plate-like connecting section 64 to the cylindrical jacket 66 of the discharge vessel 6a in the first end section 61a of the lamp 18. The connecting section 64 can be designed to form a sealing closure of the discharge chamber 8 on the first end section 61a of the lamp 1a in the axial direction A. For example, the connecting section 64 can be formed integrally with the cladding tube 6a. The connection point of connecting section 64 and jacket 66 forms the first end 60 of the emitter 1a.

FIG. 4 shows a first end section 61 d of an alternative embodiment of a low-pressure mercury vapor discharge lamp 1d, which essentially corresponds to the previously described embodiment according to FIG. 2 to 3c. In contrast to the embodiment according to FIGS. 3a to c, the discharge vessel 6d is formed in the region of the discharge path 13 between the first electrode 11 and the second electrode with a larger internal diameter D than on the axial foot section 67, which surrounds the sheathing 3 in the lateral direction X; Y.

In the first end section 61d, the discharge vessel 6d has a tapered foot section 67 with a reduced internal diameter D_{d} which is smaller than the inner diameter D of the discharge vessel 6d in the region of the cylindrical tube section 66 which surrounds the first electrode 11 and the discharge path 13.

The arrangement of the amalgam deposit 18 in a tapered foot section 67 can have a stabilizing effect on the mercury vapor pressure in the discharge chamber 8 in the region of the amalgam deposit 18. A transition section 68 can be provided between the foot section 67 and the cylindrical tube section 66, wherein the inner diameter of the discharge vessel 6 preferably changes continuously along the transition section 68. In the low-pressure mercury vapor discharge lamp 1d, the axial distance S_{d} between the incandescent body of the electrode 11 and the amalgam deposit 18 can be smaller than in a low-pressure mercury vapor discharge lamp of the previously described embodiment 1a.

In the cylindrical tube section 66, the foot section 67 and/or the transition section 68, the wall thickness w of the discharge vessel 6d can be of equal size. In the case of a low-pressure mercury vapor discharge lamp, it may be preferred that the wall thickness w of the discharge vessel is constantly the same size. For example, the wall thickness w of the discharge vessel 6d (as well as 6 or 6a) can correspond to the wall thickness w of the cylindrical tube section 66 in a connection section 64 between the sheathing 3 and the electrode 11.

The low-pressure mercury vapor discharge lamps 1b and 1c shown in FIGS. 5 and 6 differ from the low-pressure mercury vapor discharge lamp 1 described above substantially only by the shape of the first axial end of the discharge vessel and the arrangement of the adhesion agent 17b, 17c with amalgam deposit 18. It is clear that a low-pressure mercury vapor discharge lamp according to the invention can have several amalgam deposits 18 on corresponding adhesion agent sites at several positions outside the discharge path 13. For example, the low-pressure mercury vapor discharge lamp 1 could have at least one further amalgam deposit corresponding to the arrangement according to FIG. 5 and/or FIG. 6 in addition to the amalgam deposit 18 shown in FIG. 1. In the first end 60, no recess or the like that impairs the stability of the lamp needs to be provided for the amalgam, since the amalgam is advantageously fixed in the discharge chamber 18 by the adhesion agent 17b, 17c. In this way, an undesired conductive heat transfer from the temperature-controlled amalgam deposit 18 in the direction of the axial end 60 of the lamp 1b, 1c and a lamp holder (not shown in more detail) surrounding the end 60 is also prevented.

FIG. 5 shows an alternative embodiment of a low-pressure mercury vapor discharge lamp 1b according to the invention, in which the amalgam deposit 18 is arranged with an adhesion agent 17b on the inner side 63 of the discharge vessel 6b. Optionally, a heat shield 4b can be arranged between the first electrode 11 and the amalgam deposit 18. The axial distance S_{b} is dimensioned between the amalgam deposit 18 and the incandescent body of the first electrode 11 such that the temperature of the amalgam deposit 18 is independent of the discharge current of the first electrode 11. The amalgam deposit 18 is arranged with the adhesion agent 17b on the radial inner side 63 of the discharge vessel 6b facing away from the discharge region 13.

The first end section 61 b of the low-pressure mercury vapor discharge lamp 1b b can be formed corresponding to the second end section 62 by pressing of cylindrical tube of the discharge vessel 6b onto the respective contact wires 21, 22 of the electrodes 11 and 12 located opposite one another. The first end 60 of the low-pressure mercury vapor discharge lamp 1b (or 1c) can thus be formed as a pressed end 60 on the first end section 61b (or 61c) of the discharge vessel 6b (or 6c), which extends completely outside the discharge chamber 60.

FIG. 6 shows a further alternative embodiment of a low-pressure mercury vapor discharge lamp 1c according to the invention. The distance S_{c} between the amalgam deposit 18 and the incandescent body of the electrode 11 is very small. Nevertheless, the temperature of the amalgam deposit 18 is independent of the discharge current of the first electrode 11. A heat shield 4c is arranged between the electrode 11 and the amalgam deposit 18. The amalgam deposit 18 is arranged on the rear side of the heat shield 4c facing away from the electrode 11 and thus the discharge vessel 6c or its discharge region 13.

The heat shield 4c (or 4 or 4b) is preferably formed from an infrared radiation to an extent of at least 90%, at least 95%, at least 99%, preferably at least 99.9%. For example, the heat shield 4c is formed from a ceramic material or a quartz glass, in particular an amorphous quartz glass, such as a semiconductor-doped amorphous quartz glass. It is conceivable that the heat shield 4c has a surface facing the electrode 11, which surface is coated with a highly reflective material (relative to the infrared spectrum).

The adhesion agent 17c and the amalgam 18 are attached to the rear side, facing away from the electrode 11, of the heat shield 4c. Axial stops 21 are fastened to the contact wires 21 in order to fix the heat shield 4c at least in the axial direction A. The heat shield 4c has two circumferential contact sections 41 which are in contact with the inner side 63 of the discharge vessel 6c. The circumferential contact sections 41 form an almost circular reflector surface. In the circumferential direction between the circumferential contact sections 41, the heat shield 4c has two radial recesses 43 in which the contact wires 21 are guided and which each provide a gas-permeable opening between the discharge path 13 and the end section 61c, so that mercury vapor can be exchanged between the discharge path 13 and the amalgam deposit 18.

The discharge vessel 6c can be formed similar to the discharge vessel 6b previously described with respect to FIG. 5 with end sections 61c and 61b and 62 that are equal to one another.

FIG. 7 makes it clear that the discharge path 13, as defined herein, basically comprises the complete volume element of the interior of the discharge vessel 6, 6a, 6d in the region between and including the incandescent body of the first electrode 11 and the incandescent body of the second electrode 12, but not the axial end regions of the discharge vessel 6, 6a, 6d beyond the electrodes 11, 12. According to the invention, the position of the amalgam deposit 18 is located outside this discharge path 13 which is represented by dots.

FIG. 8 shows an embodiment of a low-pressure mercury vapor discharge lamp according to the invention, in which a disk-like heat shield 4 is arranged between the incandescent body of the first electrode 21 and the amalgam 18. The amalgam 18 is held on the inside of the discharge vessel by means of an adhesion agent 17. The heat shield 4 has recesses 43. The disk-like heat shield 4 has two radial recesses 43 in the circumferential direction. The heat shield 4 is configured to thermally shield the amalgam deposit 18 from the incandescent body of the first electrode 21.

FIG. 9 shows a further embodiment of a low-pressure mercury vapor discharge lamp according to the invention, in which a disk-like heat shield 4 is likewise arranged between the incandescent body of the first electrode 21 and the amalgam 18. In addition, a sleeve 80 made from a material that reflects infrared light is arranged on the inside of the discharge vessel, so that it surrounds the amalgam deposit 18 from several sides in a shell-like manner in order to thermally shield the amalgam deposit 18 from the incandescent body of the first electrode 21. The heat shield 4 carries a coating 70 made from a material that reflects infrared light, in this example aluminum. In this example, the coating 70 is arranged on the side of the heat shield 4 facing the incandescent body of the first electrode 21. Alternatively, however, it is also possible to attach the coating 70 to the opposite side or to both sides of the heat shield 4. A disk-like heat shield 4 with a coating 70 reflecting infrared light can be provided as an alternative to or in addition to the sleeve 80.

FIG. 10 shows a further embodiment of a low-pressure mercury vapor discharge lamp according to the invention, in which a layer 90 made from a material that reflects infrared light is arranged on the outside of the discharge vessel in order to thermally shield the amalgam deposit 18. Such a layer 90 can comprise, for example, aluminum or a precious metal, such as gold or silver.

Reference signs
1, 1a, 1b, 1c, 1d Low-pressure mercury vapor discharge lamp
3, 3d Sheathing
4, 4b, 4c Heat shield
6, 6a, 6d Discharge vessel
7 Receiver
8 Discharge chamber
11 First electrode
12 Second electrode
13 Discharge path
17, 17b Adhesion agent
18 Amalgam deposit
21, 22 Contact wire
23 Axial stop
25 Sealing platelets
27 Transition region
41 Circumferential contact section
43 Recess
60 First end
61, 61a, 61 d First end section
62 Second end section
63 Inner side
64 Connecting section
66 Cylindrical tube section
67 Foot section
68 Transition section
70 Coating of the heat shield
80 Sleeve
90 Layer
100 Lamp system
101, 102 Holder
103 Regulation electronics
105 Ambient temperature sensor
106 Lamp temperature sensor
107 Transmitter
121, 122 Contact receptacle
b Width
d Thickness
h Height
m Ambient medium
s, sₐ, S_{b}, S_{c}, S_{d} Distance
w Wall thickness
A Axial direction
D, D_{d} Internal diameter
X First radial direction
Y Second radial direction

1. A low-pressure mercury vapor discharge lamp comprising
a discharge vessel which encloses a discharge chamber in a gas-tight manner with said discharge chamber being provided with a filling of mercury and a filler gas, in particular a noble gas, wherein the discharge vessel has a first end section and a second end section,
a first electrode arranged on the first end section and a second electrode arranged on the second end section for maintaining a discharge along a discharge path between the first electrode and the second electrode, wherein
an amalgam deposit for regulating the mercury vapor pressure in the discharge chamber is arranged on the first end section outside the discharge path, wherein the position of the amalgam deposit is secured by means of an adhesion agent.

2. The low-pressure mercury vapor discharge lamp
according to claim 1, wherein the first electrode comprises at least one contact wire which extends from the first electrode in the discharge chamber to outside the discharge vessel,wherein the contact wire comprises a dielectric sheathing at least in sections within the discharge chamber, wherein the adhesion agent is arranged on the sheathing.

3. The low-pressure mercury vapor discharge lamp according to claim 2, wherein the sheathing is formed from, preferably consists of, quartz glass, in particular from the same material as the discharge vessel and/or wherein the sheathing sealingly encloses the contact wire (24).

4. The low-pressure mercury vapor discharge lamp according to claim 2 , wherein the sheathing extends in the form of a tape into the discharge chamber, wherein in particular the tape-shaped sheathing has a substantially rectangular cross section.

5. The low-pressure mercury vapor discharge lamp according to claim 2, wherein the adhesion agent on a lateral surface of the sheathing and/or an end face of the sheathing facing the first electrode is free of an adhesion agent.

6. The low-pressure mercury vapor discharge lamp according to claim 2, wherein the sheathing is fastened, in particular welded-on, in the first end section of the discharge vessel (6).

7. The low-pressure mercury vapor discharge lamp according to claim 1, wherein at least one heat shield arranged between the first electrode and the first end section, wherein the adhesion agent is arranged relative to the heat shield with respect to the first electrode.

8. The low pressure mercury vapor discharge lamp according to claim 7, wherein the heat shield comprises a coating reflecting infrared light.

9. The low-pressure mercury vapor discharge lamp according to claim 2,wherein the heat shield is formed by the sheathing (3) and/or wherein the heat shield is formed from a dielectric material, in particular from transparent quartz glass and/or amorphous quartz glass, preferably a semiconductor-doped amorphous quartz glass.

10. The low-pressure mercury vapor discharge lamp according to claim 1, wherein the adhesion agent is arranged on an inner side of the discharge vessel.

11. The low-pressure mercury vapor discharge lamp according to claim 1, low-pressure mercury vapor discharge lamp, wherein the amalgam deposit is equipped with an electromagnetic receiver for converting electromagnetic input signals into heat.

12. The low-pressure mercury vapor discharge lamp according to claim 11, wherein the receiver comprises the adhesion agent and/or the amalgam deposit or in that the receiver is formed separately from the amalgam deposit.

13. The low-pressure mercury vapor discharge lamp according to claim 1, further comprising a sleeve that reflects infrared light, which sleeve at least partially surrounds the amalgam deposit .

14. The low pressure mercury vapor discharge lamp according to claim 1, comprising a layer of a material that reflects infrared light arranged on the inner and/or outer side of the first end section of the discharge vessel.

15. A lamp system with athe low-pressure mercury vapor discharge lamp according to claim 1 and with an electromagnetic transmitter for exciting the electromagnetic receiver (7), wherein in particular the electromagnetic transmitter and the electromagnetic receiver are coordinated with one another such that the transmitter transmits, in particular inductively and/or capacitively, a heating current to the receiver for controlling the temperature of the amalgam deposit.
